(19) United States
(12) Patent Application Publication
(10) Pub. No.: US 2013/0167530 A1
(43) Pub. Date: Jul. 4, 2013

(54) HEAT TAKE-OUT DEVICE

(71) Applicant: Industrial Technology Research Institute, Chutung (TW)

(72) Inventors: Jui-Ching HSIEH, Taichung City (TW); Tai-Rong GUO, Zhubei City (TW); Yin-Lung HAN, Tainan City (TW); Chih-Hsi LIU, Hsinchu City (TW)

(73) Assignee: INDUSTRIAL TECHNOLOGY RESEARCH INSTITUTE, Chutung (TW)

(21) Appl. No.: 13/706,215

(22) Filed: Dec. 5, 2012

(30) Foreign Application Priority Data
Dec. 28, 2011 (TW) 100149214

(51) Int. Cl. F28D 15/02; F03G 7/04

(52) U.S. Cl. CPC F28D 15/025; F03G 7/04
USPC 60/641.2; 165/104.21

(57) ABSTRACT

A heat take-out device comprising an external tube, an internal tube and a pressure resistance element is provided. The external tube defines an evaporating region, a condensing region and an adiabatic region. The internal tube is deposed within the external tube and separated from the external tube by a flow channel. The pressure resistance element is deposed within the flow channel and adjacent to a conjoint portion between the adiabatic region and the evaporating region. The length of the pressure resistance element is shorter than that of the adiabatic region.

This application claims the benefit of Taiwan application Serial No. 100149214, filed Dec. 28, 2011, the disclosure of which is incorporated by reference herein in its entirety.

### TECHNICAL FIELD

The disclosed embodiments relate in general to a heat take-out device, and more particularly to a heat take-out device with pressure resistance element.

### BACKGROUND

In a conventional single well geothermal power generation structure, a working fluid is infused to a closed chamber for absorbing latent heat. The working fluid is further vaporized into steam for transferring the heat. The closed chamber is a long tube which extends into the earth to extract geothermal heat for power generator or geothermal heat pump. After the geothermal heat is extracted by a low temperature working fluid in the chamber, the temperature of the stratum fluid surrounding the casing of the chamber and the density of the stratum fluid surrounding the casing increases. The stratum fluid farther away from the closed chamber still maintains the state of high temperature and low density state like the stratum fluid in rock fissures. Through the density difference, the stratum fluid generates natural convection in the rock fissures for transferring the geothermal energy to a low temperature region from a high temperature region, continuously provides geothermal energy to the low temperature working fluid inside the chamber and stably maintains the efficiency of deep geothermal power generation.

The steam is condensed into a condensing working fluid after providing heat. The condensing working fluid refluxes to an evaporating region of the closed chamber at the bottom by way of gravity, and there is no need to have any capillary structure inside the cavity. The gravity-driven method has low flow resistance during condensing flow refluxing to avoid the limitation of capillary. Since the condensing fluid flows in a direction opposite to that of the steam and the fluid has viscosity, the high pressure steam, when moving fast, may push the condensing liquid back to the condensing end and make the evaporating region be deprived of working fluid. Such phenomenon, referred as entrainment limit or flooding, may deteriorate the heat take-out efficiency of the heat take-out device.

### SUMMARY

According to one embodiment, a heat take-out device comprising an external tube, an internal tube and a pressure resistance element is provided. The external tube defines an evaporating region, a condensing region and an adiabatic region. The internal tube is deposed within the external tube and separated from the external tube by a flow channel. The pressure resistance element is deposed within the flow channel and adjacent to a conjoint portion between the adiabatic region and the evaporating region. The length of the pressure resistance element is shorter than that of the adiabatic region.

### BRIEF DESCRIPTION OF THE DRAWINGS

FIG. 1 shows a cross-sectional view of a formation heat take-out device according to an embodiment of the disclosure;

FIG. 2 shows an appearance view of a pressure resistance element of FIG. 1;

FIG. 3 shows an appearance view of a pressure resistance element according to another embodiment of the disclosure;

FIG. 4 shows a cross-sectional view of the pressure resistance element of FIG. 3 being deposed between the internal tube and the external tube;

FIG. 5 shows a cross-sectional view of the pressure resistance element of FIG. 3 being deposed between the internal tube and the external tube according to another embodiment;

FIG. 6 shows a cross-sectional view of the formation heat take-out device of FIG. 1 being connected to a heat exchanger.

FIG. 7 shows an appearance view of a heat conduction member of FIG. 6; and

FIG. 8 shows a cross-sectional view of a heat conduction member according to another embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

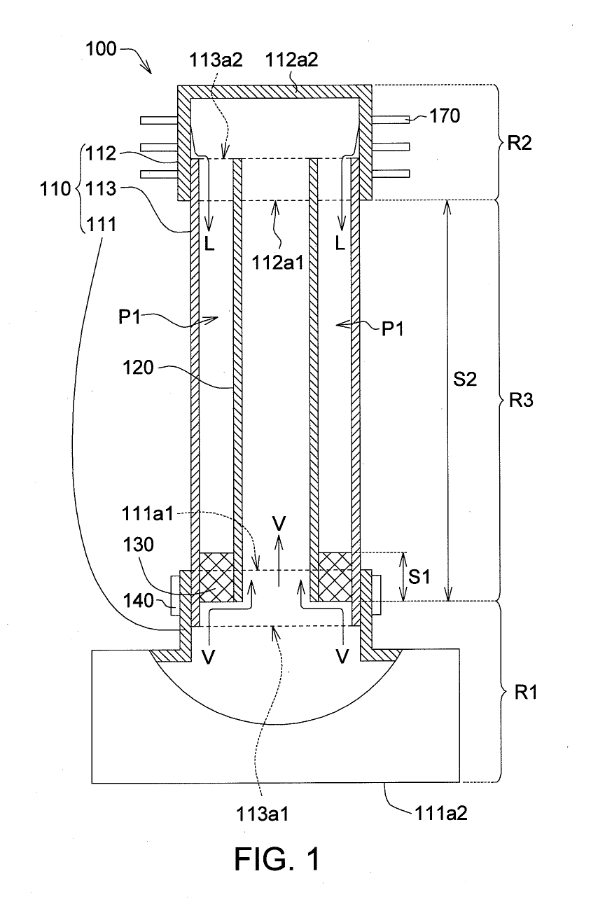

The heat take-out device, such as a formation heat take-out device, may be used in a downhole heat exchanger (DHE) for increasing the efficiency of taking out geothermal heat. Referring to FIG. 1, a cross-sectional view of a formation heat take-out device according to an embodiment of the disclosure is shown. The formation heat take-out device 100 comprises an external tube 110, an internal tube 120 and a pressure resistance element 130.

In the present embodiment of the disclosure, the center axis of the external tube 110 is collinear with the center axis of the internal tube 120. That is, the external tube 110 and the internal tube 120 are concentric tubes. However, such exemplification is not for limiting the embodiment of the disclosure.

The external tube 110 defines an evaporating region R1, a condensing region R2 and an adiabatic region R3. The formation heat take-out device 100 is vertically deposed within a geothermal well. The evaporating region R1 is located on a heat storage layer (not illustrated) of the geothermal well. The condensing region R2 may be close to or exposed from the ground (not illustrated).

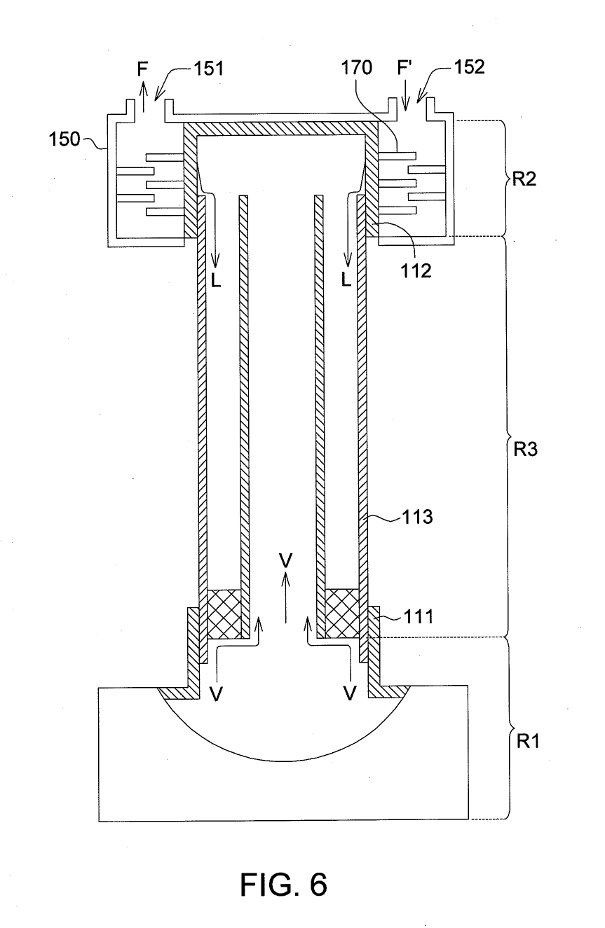

A working fluid is infused into the external tube 110. The working fluid in the evaporating region R1 absorbs the thermal energy (geothermal heat) in the earth and then is vaporized as a vapor working fluid V (with smaller density) which flows to the condensing region R2 via the adiabatic region R3 along the interior of the internal tube 120. In the condensing region R2, the vapor working fluid V condenses as a liquid working fluid L (with larger density) which flows to the evaporating region R1 along the flow channel P1 between the external tube 110 and the internal tube 120. In the condensing region R2, an external fluid F (illustrated in FIG. 6) absorbs the heat of the vapor working fluid V and then provides the mechanical power to an external power generation system or other device.

The external tube 110 is a closed tube. The external tube 110 may be realized by a single tube or composed of a plurality of separated elements. In the present embodiment of the disclosure, the external tube 110 is composed of a plurality of separated elements and the details of the external tube 110 are elaborated below.

As indicated in FIG. 1, the external tube 110 comprises an evaporating region element 111, a condensing region element 112 and an adiabatic region element 113. The adiabatic region element 113 connects to the condensing region element 112 and the evaporating region element 111. In the present embodiment of the disclosure, the evaporating region element 111 and the condensing region element 112 may be realized by a hollowed tube or a heat exchanger. The heat exchanger is such as a fin-type heat exchanger, a shell-tube heat exchanger, a heat-pipe heat exchanger, a plate-type heat exchanger, a double-tube type heat exchanger or other heat exchanger capable of increasing the area and efficiency of heat exchange.

In the present embodiment of the disclosure, the cross-sections of the evaporating region element 111, the condensing region element 112 and the adiabatic region element 113 are such as a round tube or a hollow cylinder. In another embodiment, the evaporating region element 111, the cross-sections of the condensing region element 112 and the adiabatic region element 113 are such as an ellipse or a polygon. Examples of polygon include triangle and rectangle.

As indicated in FIG. 1, the adiabatic region element 113 has a first opening 113a1 and a third opening 113a2, and the evaporating region element 111 has a second opening 111a1 and a closed end 111a2. The first opening 113a1 and the second opening 111a1 are interconnected with each other. The evaporating region element 111 and the adiabatic region element 113 may be connected by way of interference fit, bonding, fastening or locking. In the present embodiment of the disclosure, the evaporating region element 111 and the adiabatic region element 113 are bound by a chip 140.

In the present embodiment of the disclosure, the adiabatic region element 113 enters the second opening 111a1 of the evaporating region element 111 to be engaged with the evaporating region element 111. In another embodiment, the evaporating region element 111 enters the first opening 113a1 of the adiabatic region element 113 to be engaged with the adiabatic region element 113.

In addition, a sealing member (not illustrated) may be disposed between the adiabatic region element 113 and the evaporating region element 111 for enhancing the bonding between the adiabatic region element 113 and the evaporating region element 111. The sealing member is such as sealing glue or a sealing ring.

As indicated in FIG. 1, the condensing region element 112 has a fourth opening 112a1 and a closed end 112a2. The third opening 113a2 of the adiabatic region element 113 and the fourth opening 112a1 of the condensing region element 112 are interconnected with each other.

Despite that the binding method between the condensing region element 112 and the adiabatic region element 113 is not illustrated, the bonding between the condensing region element 112 and the adiabatic region element 113 may be similar to that between the evaporating region element 111 and the adiabatic region element 113.

In the present embodiment of the disclosure, the adiabatic region element 113 enters the fourth opening 112a1 of the condensing region element 112 to be engaged with the condensing region element 112. In another embodiment, the condensing region element 112 may enter the third opening 113a2 of the adiabatic region element 113 to be engaged with the adiabatic region element 113.

In addition, a sealing member (not illustrated) may be disposed between the adiabatic region element 113 and the condensing region element 112 for enhancing the bonding between the adiabatic region element 113 and the condensing region element 112. The sealing member is such as sealing glue or sealing ring.

In the present embodiment of the disclosure, the evaporating region element 111, the adiabatic region element 113 and the condensing region element 112 are manufactured separately and then are assembled together to form an external tube 110. In another embodiment, the evaporating region element 111, the adiabatic region element 113 and the condensing region element 112 are integrally formed in one piece. In addition, the condensing region element 112 may have a feed opening (not illustrated). After the evaporating region element 111, the adiabatic region element 113 and the condensing region element 112 are assembled together to form an external tube 110, a working fluid may be infused into the external tube 110 via the feed opening, non-condensable gas is exhausted, and then the filling tube is sealed.

The evaporating region element 111 of the external tube 110 is made of a material with high thermal conductivity such as a metal selected from a group composed of copper, iron, stainless steel and a combination thereof. The evaporating region element 111 may be made of corrosion resistant or high temperature resistant material selected from polymers, ceramics, or metals (such as stainless steel). In some embodiments, polymers may be realized by rubber or plastics (such as engineering plastics), are such as polypropylene (PP) containing glass fiber, polyether ether ketone (PEEK), PEEK containing glass fiber, polyphenylene sulfide (PPS), PPS containing glass fiber, polyether sulfon (PES), polyetherimide (PEI) and polytylene (PE). In an embodiment, the thermal conductivity of the material of the evaporating region element 111 ranges between 10 to 400 W/mK.

The condensing region element 112 of the external tube 110 is made of a material with high thermal conductivity such as a metal selected from a group composed of copper, iron, stainless steel and a combination thereof. The condensing region element 112 may be made of polymers or ceramics. In some embodiments, polymers may be rubber or plastics (such as engineering plastics), polypropylene (PP) containing glass fiber, polyether ether ketone (PEEK), PEEK containing glass fiber, polyphenylene sulfide (PPS), PPS containing glass fiber, polyether sulfon (PES), polyetherimide (PEI) and polytylene (PE). In an embodiment, the thermal conductivity of the material of the condensing region element 112 ranges between 10 to 400 W/m K.

The adiabatic region element 113 of the external tube 110 is made of a resistant material which resists corrosion or high temperature and does not react with the internal working fluid. The adiabatic region element 113 is made of a material with low thermal conductivity such as polymers or ceramics. In some embodiments, polymers may be realized by rubber or plastics (such as engineering plastics), are such as PP (PP), polypropylene (PP) containing glass fiber, polyether ether ketone (PEEK), PEEK containing glass fiber, polyphenylene sulfide (PPS), PPS containing glass fiber, polyether sulfon (PES), polyetherimide (PEI) and polytylene (PE). In an embodiment, the thermal conductivity of the material of the evaporating region element 111 ranges between 0.0264 to 0.5 W/mK.

The adiabatic region element 113 may be realized by a single- or multi-layered structure. Let multi-layered structure be taken for example. The adiabatic region element 113 comprises an inner layer structure and an outer layer structure. The outer layer structure covers the inner layer structure. The materials of the inner and the outer layer structures independently may be realized by a material with high thermal conductivity or a material with low thermal conductivity. The material with low thermal conductivity is such as polymers or ceramics, and the material with high thermal conductivity is such as a metal selected from a group composed of copper, iron, stainless steel and a combination thereof. In an embodiment, the inner layer structure of the adiabatic region element 113 is formed by the said material with high or low thermal conductivity, and the outer layer structure is formed by the said material with low thermal conductivity. In another embodiment, the inner and the outer layer structures of the adiabatic region element 113 are both made of a material with high thermal conductivity and together form a double-layered metallic adiabatic structure, wherein a vacuum space is contained between the inner and the outer layers.

The internal tube 120 is made of a resistant material which resists corrosion or high temperature and does not react with the working fluid. The internal tube 120 is formed by a material with low thermal conductivity such as polymers or ceramics. In some embodiments, polymers may be realized by rubber or plastics (such as engineering plastics), are such as PP (PP), polypropylene (PP) containing glass fiber, polyether ether ketone (PEEK), PEEK containing glass fiber, polyphenylene sulfide (PPS), PPS containing glass fiber, polyether sulfon (PES), polyetherimide (PEI) and polytylene (PE). In an embodiment, the thermal conductivity of the material of the internal tube 120 ranges between 0.0264 to 0.5 W/mK.

The internal tube 120 may be realized by a single- or multi-layered structure. Let multi-layered structure be taken for example. The adiabatic region element 113 comprises an inner layer structure and an outer layer structure. The outer layer structure covers the inner layer structure. The materials of the inner and the outer layer structures independently may be realized by a material with high thermal conductivity or a material with low thermal conductivity. The material with low thermal conductivity is such as high polymers or ceramics, and the material with high thermal conductivity is such as a metal selected from a group composed of copper, iron, stainless steel and a combination thereof. In an embodiment, the inner layer structure of the internal tube 120 is formed by the said material with high or low thermal conductivity, and the outer layer structure is formed by the said material with low thermal conductivity. In another embodiment, the inner and the outer layer structures of the internal tube 120 are both formed by a material with high thermal conductivity, wherein a vacuum space is contained between the inner and the outer layers.

In an embodiment, the materials and structure of the formation heat take-out device 100 are designed to be able to resist about 10˜40 kgf/cm² and at least 90° C.

As indicated in FIG. 1, the internal tube 120 is deposed within the external tube 110 and separated from the external tube 110 by a flow channel P1. After having condensed, the liquid working fluid L may flow within the flow channel P1 by gravity. In the present embodiment of the disclosure, the length of the internal tube 120 is larger than the length S2 of the adiabatic region R3. In another embodiment, the length of the internal tube 120 may be smaller than or equal to the length S2 of the adiabatic region R3.

As indicated in FIG. 1, the pressure resistance element 130 is deposed within the flow channel P1 and adjacent to a conjoint portion between the adiabatic region R3 and the evaporating region R1. In the present embodiment of the disclosure, the pressure resistance element 130 is deposed within the adiabatic region R3. In another embodiment, the pressure resistance element 130 may be partly within the evaporating region R1. In the present embodiment of the disclosure, the entire pressure resistance element 130 is deposed within the flow channel P1. In another embodiment, a part of the pressure resistance element 130 may be deposed within the flow channel P1 and another part of the pressure resistance element 130 may be deposed outside the flow channel P1 such as protruded from the end portion of the internal tube 120.

The pressure resistance element 130 generates resistance on the vapor working fluid V flowing towards the condensing region R2 (that is, a pressure difference ΔP is formed between the two ends of the pressure resistance element 130) to reduce the vapor working fluid V entering the flow channel P1 to resist the liquid working fluid L flowing towards the evaporating region R1 inside the flow channel P1. By doing so, the flooding phenomenon can thus be improved or avoided, and the objective of vapor-liquid separation is achieved. Through the capillarity effect and gravity, the liquid working fluid L flowing towards the evaporating region R1 may flow to the evaporating region R1 via the pressure resistance element 130.

The resistance generated on the vapor working fluid V by the pressure resistance element 130 is mainly associated with a number of factors such as the length S1, the cross-section area of flow channel P1 and the porosity of the pressure resistance element 130. Any pressure resistance element 130 that generates resistance on the vapor working fluid V would do, and the present embodiment of the disclosure does not have further restrictions on the said parameter.

The pressure loss ΔP caused by the pressure resistance element 130 can be obtained from formula (1). Designation D denotes characteristic dimension of the pressure resistance element 130. Designation f, which denotes the friction coefficient of the pressure resistance element 130, is mainly associated with Reynolds number and surface roughness and may be obtained by looking up the table. Designation ρ denotes the density of a working fluid. Designation V denotes the flow velocity of a working fluid inside the pressure resistance element 130.

$$Δ P = \frac{S 1}{D} f \frac{1}{2} ρ {V}^{2} \qquad ( 1 )$$

Preferably but not restrictively the pressure resistance element 130 comprises a bonding material (not illustrated), and the pressure resistance element 130 in the flow channel P1 may be engaged between the internal tube 120 and the external tube 110. The bonding material is such as a viscose. In another embodiment, through suitable design of dimension, the pressure resistance element 130 may be tightly engaged between the internal tube 120 and the external tube 110 for binding the internal tube 120 and the external tube 110.

As indicated in FIG. 1, the length S1 of the pressure resistance element 130 may be smaller than the length S2 of the adiabatic region R3. In an embodiment, the length S1 of the pressure resistance element 130 is smaller than a half of the length S2 of the adiabatic region R3. However, such exemplification is not for limiting the embodiments of the disclosure. In the present embodiment of the disclosure, the length S1 of the pressure resistance element 130 is much shorter than the length S2 of the adiabatic region R3, and can hardly affect the flow of the liquid working fluid L. In an embodiment, the length S1 of the pressure resistance element 130 is about 1/100˜ 1/10 of the length S2 of the adiabatic region R3.

In the present embodiment of the disclosure, the structure of the pressure resistance element 130 may be realized by a porous structure via which the liquid working fluid L flows to the evaporating region R2 through the capillarity effect and gravity. Details of the structure of the pressure resistance element 130 are elaborated below.

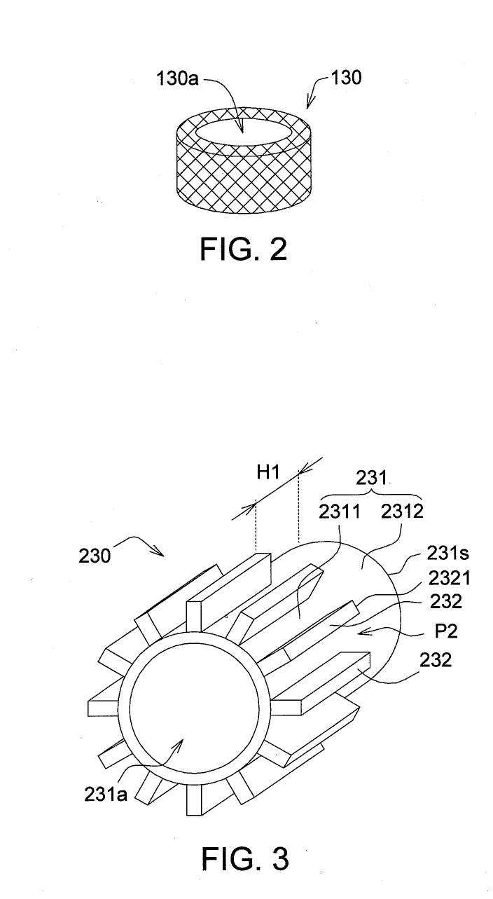

Referring to FIG. 2, an appearance view of a pressure resistance element of FIG. 1 is shown. The pressure resistance element 130 is such as a ring or a mesh structure with an opening 130a. The internal tube 120 (illustrated in FIG. 1) may enter the opening 130a of the pressure resistance element 130 to be engaged by the pressure resistance element 130. The pressure resistance element 130 may be formed by a material with low thermal conductivity such as ceramics or high polymers (like the said high polymers, natural fiber or synthetic fiber). In another embodiment, the pressure resistance element 130 may also be formed by a material with high thermal conductivity such as a metal selected from a group composed of copper, iron, stainless steel and a combination thereof. If the material of the pressure resistance element 130 is metal, then the pressure resistance element 130 may be formed by way of powder metallurgy.

In an embodiment, a mesh structure may have a mesh number of 4˜2500 (4˜2500 meshes per square inch), and the porosity rate of a powder metallurgy structure may range between 0.1 to 0.9.

In the present embodiment of the disclosure, the pressure resistance element 130 is a continuous structure. In another embodiment despite having not been illustrated, the pressure resistance element 130 may comprise a plurality of separated structures (not illustrated) such as a plurality of segmented bumps or ring structures. The separated structures can be integrally or separately deposed within the flow channel P1.

The structure of the pressure resistance element 130 is not limited to a porous structure as exemplified above. Another structure of the pressure resistance element is disclosed below with the illustration of FIG. 3.

Referring to FIG. 3, an appearance view of a pressure resistance element according to another embodiment of the disclosure is shown. The pressure resistance element 230 comprises a tube body 231 and a plurality of protrusions 232, wherein a channel P2 is defined between adjacent two protrusions 232. The protrusions 232 and the channels P2 generate a higher pressure drop on the vapor working fluid V to avoid the vapor working fluid V easily passing through the pressure resistance element 230.

The pressure resistance element 230 may be formed by way of such as extrusion or ejection. If the pressure resistance element 230 is formed by way of extrusion, the material of the pressure resistance element 230 may be realized by such as aluminum. If the pressure resistance element 230 is formed by way of ejection, the material of the pressure resistance element 230 may be realized by such as plastics. If the structure illustrated in FIG. 3 cannot be formed by way of extrusion or ejection in one process, then mechanic processing can be used to complete the formation of the structure illustrated in FIG. 3. Examples of mechanic processing include turning, milling, grinding, hot melt, casting or other suitable processing. In another embodiment, the material of the pressure resistance element 230 may be realized by metal (selected from a group composed of copper, iron, stainless steel and a combination thereof), ceramics or high polymers (such as the said high polymers). Alternatively, the material of the pressure resistance element 230 may be similar to that of the pressure resistance element 130.

The protrusions 232 may generate a resistance on the vapor working fluid V flowing towards the condensing region R2 (that is, a pressure difference ΔP is formed between two ends of the pressure resistance element 230) to avoid the vapor working fluid V entering the flow channel P1 (that is, to avoid or improve the flooding phenomenon). The more the protrusions 232 (that is, the smaller the cross-section of the channel), the larger the pressure difference ΔP. In an embodiment, the number of the protrusions 232 may range from 4 to 36. However, the number of the protrusions 232 is determined according to the magnitude of the pressure difference ΔP, and the present embodiment of the disclosure does not have further restrictions on the number of the protrusions 232. Furthermore, the liquid working fluid L inside the flow channel P1 may flow to the evaporating region R1 via the channel P2 between adjacent two protrusions 232.

In the present embodiment of the disclosure, the tube body 231 comprises a protrusion disposition portion 2311 and a tube connection portion 2312. The protrusions 232 are deposed within protrusion disposition portion 2311. The end portions 2321 of the protrusions 232 and the end surface 231s of the tube body 231 are spaced by a segment difference distance H1. The segment difference distance H1 is the tube connection portion 2312. In addition, the internal tube 120 may be connected to the tube connection portion 2312 of the tube body 231, and detailed description is disclosed below.

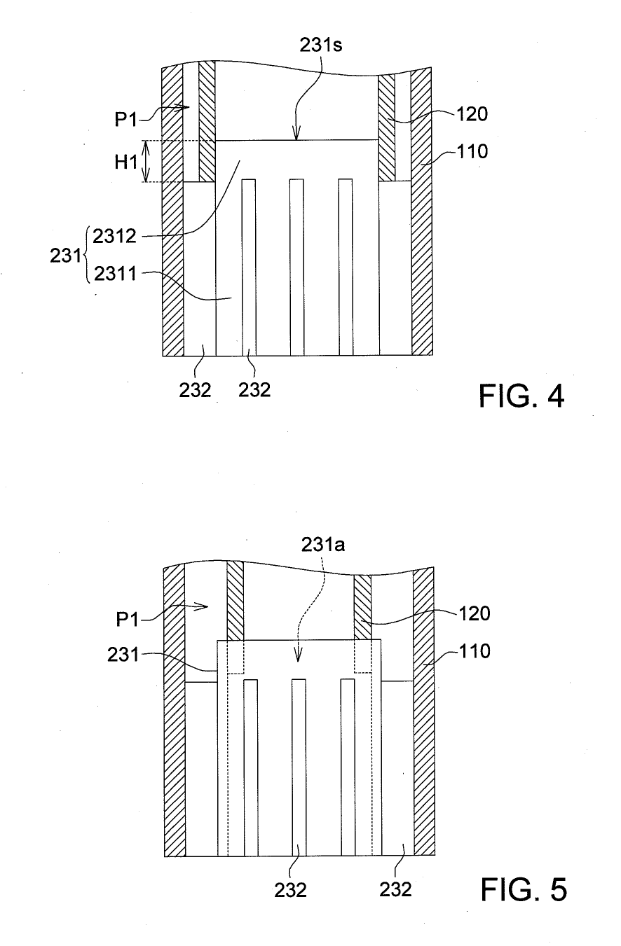

Referring to FIG. 4, a cross-sectional view of the pressure resistance element of FIG. 3 being deposed between the internal tube and the external tube is shown. In the present embodiment of the disclosure, the pressure resistance element 230 may connect the external tube 110 and the internal tube 120. For example, the internal tube 120 is mounted on the tube connection portion 2312 to be engaged with the pressure resistance element 230 by way of tight fit or bonding. The external tube 110 and protrusions 232 may be engaged by way of tight fir or bonding. In another embodiment, the pressure resistance element 230 may be connected to only one of the external tube 110 and the internal tube 120.

As indicated in FIG. 4, in the present embodiment of the disclosure, the internal tube 120 may lean on protrusions 232. The insertion depth of the internal tube 120 may be controlled through the design of the segment difference distance H1. In another embodiment, the internal tube 120 does not lean on the protrusions 232 but are separated from the protrusions 232 by a distance.

Referring to FIG. 5, a cross-sectional view of the pressure resistance element of FIG. 3 being deposed between the internal tube and the external tube according to another embodiment. The tube body 231 has a through hole 231a. When the pressure resistance element 230 is deposed between the external tube 110 and the internal tube 120, the internal tube 120 may be deposed within the through hole 231a of the tube body 231 to be engaged with the pressure resistance element 230 by way of tight fir or bonding.

To summarize, the pressure resistance element may be realized by a porous structure, a protrusion structure, a mesh structure or other structure, and any structures generating a resistance on the vapor working fluid V are referred as a pressure resistance element in the embodiments of the disclosure.

Referring to FIG. 6, a cross-sectional view of the formation heat take-out device of FIG. 1 being connected to a heat exchanger is shown.

The condensing region element 112 may be connected to another heat exchanger 150. The heat exchanger 150 has an exit 151 and an entrance 152. The external fluid F enters the heat exchanger 150 via the entrance 152 and then flows to a power generation system from the exit 151.

Through the evaporating region element 111, the liquid working fluid L flowing from the condensing region element 112 (or the condensing region R2) fast absorbs the geothermal heat and then is vaporized as a vapor working fluid V which flows to the condensing region element 112 via the internal tube 120. After the vapor working fluid V reaches the condensing region element 112, through the assistance of the condensing region element 112 and the heat exchanger 150, the external fluid F inside the heat exchanger 150 flows out from the exit 151 (the external fluid F refers to the fluid having absorbed the heat of the vapor working fluid V) for generating power or other use. An external fluid F′ with lower temperature (such as lower than the temperature of the external fluid F) is provided to the heat exchanger 150 via the entrance 152. In the condensing region element 112, after the heat of the vapor working fluid V is absorbed by the external fluid F, the vapor working fluid V condenses on the inner casing of the external tube 110 as a liquid working fluid L, which flows to the evaporating region element 111 via the flow channel P1 along the casing inside the external tube 110 by gravity. The temperature on which the temperature is relatively lower than that of the vapor working fluid V. In an embodiment, the formation heat take-out device 100 is such as vertically flows deposed within the geothermal well.

In another embodiment, the evaporating region element 111 may be connected to another heat exchanger (similar to the heat exchanger 150) to assist the liquid working fluid L flowing from the condensing region element 112 absorbing the geothermal heat more quickly and being evaporated as a vapor working fluid V.

As indicated in FIG. 6, the formation heat take-out device 100 further comprises at least one heat conduction member 170 protruded from the outer wall of the condensing region element 112 and disposed on the condensing region element 112. Moreover, the position of the heat conduction member 170 corresponds to the entrance 152, such that the external fluid F′, after entering the entrance 152, immediately contacts the protruded heat conduction member 170 to facilitate heat transfer between the vapor working fluid V and the external fluid F′.

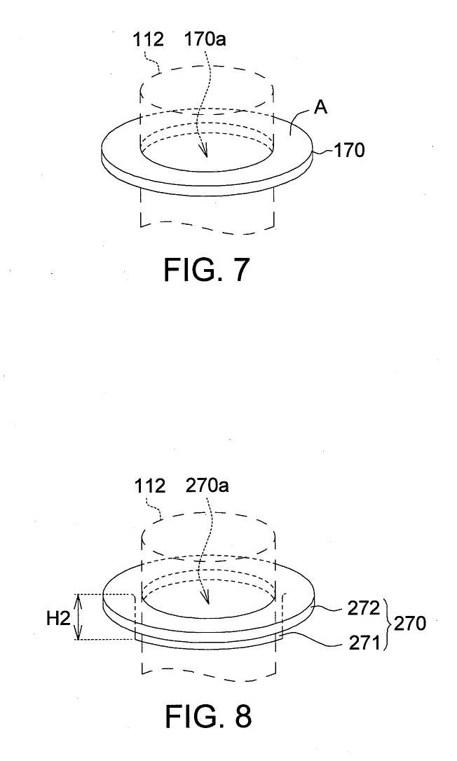

Referring to FIG. 7, an appearance view of a heat conduction member of FIG. 6 is shown. The heat conduction member 170 has an opening 170a by which the heat conduction member 170 is disposed on the condensing region element 112. The heat conduction member 170 provides a large heat conduction and convection area which facilitates heat transfer between the vapor working fluid V and the external fluid F′.

In addition, the heat conduction member 170 is formed by a material with large thermal conductivity such as a metal selected from a group composed of gold, aluminum, copper, iron, stainless steel and a combination thereof. The heat conduction member 170 may be formed by way of stamping, processing or plastic forming.

As indicated in FIG. 7, the entire heat conduction member 170 is a flat thin plate. However, such exemplification is not for limiting the embodiments of the disclosure embodiment, and another embodiment of the heat conduction member is disclosed below.

Referring to FIG. 8, a cross-sectional view of a heat conduction member according to another embodiment of the disclosure is shown. The heat conduction member 270 comprises a connection portion 271 and a protrusion portion 272. The connection portion 271 forms an opening 270a and is connected to the condensing region element 112. The protrusion portion 272 is connected to the connection portion 271, and protruded from the outer wall of the condensing region element 112 to facilitate heat transfer between the vapor working fluid V and the external fluid F′.

The height of the connection portion 271 is H2, such that the connection portion 271 may provide a large inner wall area contacting the condensing region element 112 to facilitate heat transfer between the vapor working fluid V and the external fluid F′.

The materials and formation methods of the heat conduction member 270 are similar to that of the heat conduction member 170, and are not repeated here.

According to the formation heat take-out device of the above embodiments of the disclosure, the pressure resistance element generate a pressure resistance on the vapor working fluid flowing towards the condensing region to avoid the vapor working fluid V entering the flow channel P1 to resist the liquid working fluid Therefore, the flooding phenomenon can be avoided or improved.

The liquid working fluid L may selectively use an external power (such as a pump) to assist circulation of the fluid.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A heat take-out device, comprising:
an external tube, which defines an evaporating region, a condensing region and an adiabatic region;
an internal tube deposed within the external tube and separated from the external tube by a flow channel; and
a pressure resistance element deposed within the flow channel and adjacent to a conjoint portion between the adiabatic region and the evaporating region, wherein the length of the pressure resistance element is shorter than that of the adiabatic region.

2. The heat take-out device according to claim 1, wherein the pressure resistance element is a ring structure or a mesh structure.

3. The heat take-out device according to claim 1, wherein the pressure resistance element comprises a plurality of separated structures.

4. The heat take-out device according to claim 1, wherein the pressure resistance element comprises:
a tube body; and
a plurality of protrusion connected to an outer wall of the tube body, wherein a channel is defined between adjacent two protrusions.

5. The heat take-out device according to claim 4, wherein the tube body comprises a protrusion disposition portion and a tube connection portion, the protrusions is deposed within the protrusion disposition portion, and the internal tube is connected to the tube connection portion.

6. The heat take-out device according to claim 1, wherein the length of the pressure resistance element is smaller than a half of the length of the adiabatic region.

7. The heat take-out device according to claim 1, wherein the external tube comprises:
a condensing region element;
an evaporating region element; and
an adiabatic region element connecting the condensing region element and the evaporating region element.

8. The heat take-out device according to claim 7, wherein the adiabatic region element has a first opening, the evaporating region element has a second opening, and the first opening and the second opening are interconnected with each other.

9. The heat take-out device according to claim 7, wherein the adiabatic region element has a third opening, the condensing region element has a fourth opening, and the third opening and the fourth opening are interconnected with each other.

10. The heat take-out device according to claim 7, wherein the adiabatic region element is formed by a material with low thermal conductivity.

11. The heat take-out device according to claim 7, wherein the adiabatic region element comprises:
an inner layer structure; and
an outer layer structure covering the inner layer structure.

12. The heat take-out device according to claim 11, wherein the inner layer structure is a material with high thermal conductivity or a material with low thermal conductivity, and the outer layer structure independently is a material with high thermal conductivity or a material with low thermal conductivity.

13. The heat take-out device according to claim 1, further comprising:
a heat conduction member having an opening by which the heat conduction member is disposed on the condensing region.

14. The heat take-out device according to claim 13, wherein the heat conduction member comprises:
a connection portion surrounding the opening and being connected to the condensing region; and
a protrusion portion connected to the connection portion and protruded from the condensing region.
